(19) United States
(12) Patent Application Publication
(10) Pub. No.: US 2021/0086506 A1
(43) Pub. Date: Mar. 25, 2021

(54) PRINTER HEAD CONTROL DEVICE

(71) Applicant: TOSHIBA TEC KABUSHIKI KAISHA, Tokyo (JP)

(72) Inventor: Ryuta NAGANE, Sunto Shizuoka (JP)

(21) Appl. No.: 17/005,276

(22) Filed: Aug. 27, 2020

(30) Foreign Application Priority Data
Sep. 25, 2019 (JP) 2019-174544

(51) Int. Cl. B41J 2/045; G06K 15/02

(52) U.S. Cl. CPC B41J 2/04521; B41J 2/04586; G06K 15/1894

(57) ABSTRACT

A printer head controller includes memory for storing command configuration information for a packet to be transmitted to a printer head, memory for storing print data to be transmitted to the printer head, and memory for storing printing parameters for the printer head. A command get circuit acquires commands included in the command configuration information. A data get circuit acquires the print data from the memory when a print command is in the configuration information and setting data from the memory when a setting command is in the command configuration information. A generation circuit generates the packets including the command(s) and data associated with the command(s) as acquired by the data get circuit.

### CROSS-REFERENCE TO RELATED APPLICATIONS

This application is based upon and claims the benefit of priority from Japanese Patent Application No. 2019-174544, filed on Sep. 25, 2019, the entire contents of which are incorporated herein by reference.

### FIELD

Embodiments described herein relate generally to a printer head controller.

### BACKGROUND

In the inkjet printer, there are several ways in which a controller transmits print data and setting data (e.g., printer settings) to the inkjet head. In one example, a controller transmits print data and setting data to the inkjet head through a common serial input terminal. In this manner, the controller transmits the setting data to the inkjet head, and then sequentially sends the printing data to the inkjet head according to a synchronization signal. In another example, the controller sends the print data and the setting data to the inkjet head through independent serial input terminals.

However, in the common serial terminal method, the transmission interval between pieces of print data transmitted is extremely short. One reason for this is because the transmission interval relates to the printing frequency, the transmission speed, and the like. In view of the data size (length) of the setting data, the controller cannot transmit the setting data to the inkjet head while the print data is being transmitted to the inkjet head in the conventional art. Therefore, the controller only transmits the setting data to the inkjet head during non-printing times (that is, when print data is not in the process of being sent). Thus, the controller cannot change or adjust a setting, such a driving waveform, of the inkjet head, in the middle of a long, continuous printing job during which the temperature inside the printer might change. Therefore, in the conventional method, the printing quality may be deteriorated during a later stage of such a printing job since printer settings cannot be updated or changed during the performance of such a printing job.

In the independent serial terminals method, the controller can transmit the setting data to the inkjet head even while the print data is being transmitted to the inkjet head. That is, the controller can change a setting of the inkjet head, such as a drive waveform, in real-time in response to a temperature change during printing. Furthermore, the inkjet head receives the setting data at a specific terminal for setting data and the print data at a specific terminal for print data which are physically separated from each other. Therefore, the inkjet head does not need to otherwise distinguish the types of data being transmitted from the controller. However, with this method, a plurality of signal lines are required to connect between the controller and the printer head.

### BRIEF DESCRIPTION OF THE DRAWINGS

FIG. 1 is a block diagram illustrating a configuration example of an inkjet printer according to an embodiment.

FIG. 2 is a schematic diagram illustrating an exemplary configuration of a setting data buffer according to an embodiment.

FIG. 3 is a schematic diagram illustrating an exemplary configuration of a setting data memory according to an embodiment.

FIG. 4 is a schematic diagram illustrating an example of a configuration of a command memory according to an embodiment.

FIG. 5 is a block diagram illustrating an exemplary configuration of a control signal circuit according to an embodiment.

FIG. 6 is a diagram illustrating a configuration example of a control signal according to an embodiment.

FIG. 7 is a diagram illustrating an example of an operation of generating a control signal by a controller according to an embodiment.

FIG. 8 is a diagram illustrating an example of reception of a control signal according to an embodiment.

FIG. 9 is a diagram illustrating a copying/transfer of setting data in an example illustrated in FIG. 8.

FIG. 10 is a diagram illustrating another example of a reception of a control signal according to tan embodiment.

FIG. 11 is a diagram illustrating a copying/transfer of setting data in an example illustrated in FIG. 10.

FIG. 12 is a diagram illustrating another example of a reception of a control signal according to an embodiment.

FIG. 13 is a diagram illustrating a copying/transfer of setting data in an example illustrated in FIG. 12.

### DETAILED DESCRIPTION

According to an embodiment, a controller of a printer head includes a command memory, a print data memory, a setting data memory, a command get circuit, a data get circuit, a generation circuit, and a transmission circuit. The command memory indicates a configuration of a packet for the printer head, and stores configuration information including two or more commands related to the printing. The print data memory stores print data. The setting data memory stores setting data relating to printing. The command get circuit acquires the commands included in the configuration information from the command memory. The data get circuit acquires the print data from the print data memory when a print command is included in the configuration information and acquires the setting data from the setting data memory when the configuration information includes a setting command. The generation circuit generates a packet for storing the two or more commands included in the configuration information and the data acquired by the data get circuit.

In an embodiment, it is possible to transmit a control signal from a controller including several types of commands/settings relating to printing to a printer head.

Hereinafter, example embodiments will be with reference to the accompanying drawings.

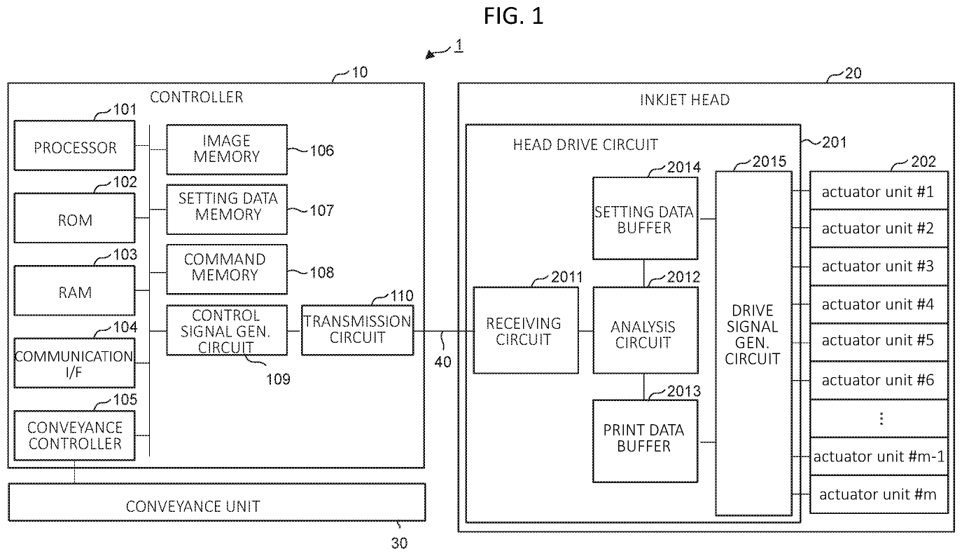

FIG. 1 is a block diagram illustrating a configuration example of an inkjet printer 1. The inkjet printer 1 includes a controller 10, an inkjet head 20, and a conveyance unit 30.

The controller 10 transmits a control signal to the inkjet head 20 via a signal line 40, and controls operation of the inkjet head 20. The signal line 40 may constitute a common path so as to transmit a signal at a common serial input terminal regardless of data stored in a control signal. The signal line 40 may be one line of a single-ended signal or one set of two lines of a differential signal.

A control signal transmitted from the controller 10 to the inkjet head 20 will be described. The control signal is a packet for storing a command relating to printing between a start byte (or a start bit) and NOP (No Operation or null operation). The start byte indicates a start of the control signal. The NOP corresponds to an end command indicating an end of the control signal. The commands relating to printing are described in the following as three types of commands, (a print command, a setting command, and an execution command) as examples, but additional types of commands may be utilized in other examples.

The print command is a command for defining an attribute of print data associated with the print command. It is assumed that the print data stored in the control signal is data for one line. When the control signal stores the print command, the control signal also stores the print data associated with the print command.

The setting command is a command for defining an attribute of setting data associated with the setting command. The setting command includes designation of a buffer position and a size that are the storage destinations of the setting data accompanying the setting command. When the control signal stores the setting command, the control signal also stores the setting data associated with the setting command.

The execution command is a command for instructing execution of the setting data. For example, the execution command is a command for instructing reflection of the setting data. The reflection of the setting data is reflection of the setting data to drive signals for actuators #1 to #m included in an actuator unit 202, which will be described later. Since the setting data is reflected in the driving signal in response to holding in a setting data buffer 2014, the reflection of the setting data is related to saving of the setting data in the setting data buffer 2014. When the control signal stores the execution command, the control signal does not store the data associated with the execution command.

The control signal includes a single-command control signal and a composite-command control signal. The single-command control signal is a control signal for storing one command related to printing. In the following description, a single-command control signal for storing a print command is also referred to as a print control signal. A single-command control signal for storing a setting command is also referred to as a setting control signal. A single-command control signal for storing an execution command is also referred to as an execution setting control signal. A typical configuration example of the single-command control signal will be described later.

The composite-command control signal is a control signal for storing two or more different types of commands for printing. In the following description, a composite-command control signal for storing two commands of a print command and a setting command is also referred to as a print/setting control signal. A composite-command control signal for storing two commands of the setting command and the execution command is also referred to as a setting and execution setting control signal. A composite-command control signal for storing two commands of a print command and an execution command is also referred to as a print and execution setting control signal. A composite-command control signal for storing three commands of a print command, a setting command, and an execution command is also referred to as a print/setting/execution setting control signal. A typical configuration example of the composite-command control signal will be described later.

The controller 10 includes a processor 101, a ROM (Read Only Memory) 102, a RAM (Random Access Memory) 103, a communication I/F (interface) 104, a conveyance controller 105, an image memory 106, a setting data memory 107, a command memory 108, a control signal circuit 109, and a transmission circuit 110. The units are connected to each other so as to be capable of data communication.

The processor 101 controls the overall operation of the controller 10. For example, the processor 101 is a central processing unit (CPU). The processor 101 implements various types of processing by executing a program stored in an internal memory, the ROM 102, or the like in advance.

The ROM 102 is a non-volatile memory that stores a program for control, control data, and the like in advance. The ROM 102 is incorporated in the controller 10 in a state where the control program, the control data, and the like are stored in a manufacturing stage.

The RAM 103 is a volatile memory. The RAM 103 temporarily stores data and the like that are being processed by the processor 101. The RAM 103 stores various application programs based on instructions from the processor 101. Further, the RAM 103 may store data necessary for execution of the application programs, execution results of the application programs, and the like.

The communication I/F 104 is an interface for transmitting/receiving data to/from another device via a network (not illustrated). The communication I/F 104 is an interface for transmitting/receiving data to/from another device via a network (not illustrated). For example, the communication I/F 104 is an interface that supports LAN (Local Area Network) connection. For example, the communication I/F 104 receives image data for forming an image on a recording sheet from another apparatus.

The conveyance controller 105 controls an operation of the conveyance unit 30 in accordance with an instruction from the processor 101.

The image memory 106 is a memory that stores print data for forming an image on a recording sheet by the inkjet head 20. The image memory 106 is also referred to as a print data memory. For example, the image memory 106 is a dual-port memory in which print data is written by the processor 101 and the print data for every line of the print is acquired line-by-line by the control signal circuit 109. The print data can be gradation-converted data. Here, the description will be given assuming that the print data is data having sixteen gradations, but the number of gradations is not limited thereto. The print data is generated based on the image data by the processor 101.

The setting data memory 107 is a memory that stores setting data. For example, the setting data memory 107 is a dual-port memory in which the setting data is written by the processor 101 and acquired by the control signal generating circuit 109. The setting data is data relating to a setting for an operation of the plurality of actuators #1 to #m included in the actuator unit 202. For example, the setting data includes data relating to setting a length of time for expanding or contracting an ink chamber corresponding to each of the actuators #1 to #m.

The command memory 108 stores configuration information for each control signal to be transmitted from the controller 10 to the inkjet head 20. The configuration information indicates the configuration of the control signal to be sent to the inkjet head 20. Each control signal includes one or more commands related to printing. For example, the command memory 108 is a dual-port memory in which the configuration information is written by the processor 101 and read by the control signal circuit 109.

The control signal circuit 109 is a circuit that generates a control signal for storing one or more commands related to printing. For example, the control signal circuit 109 is constituted by a field programmable gate array (FPGA) or the like. In that case, the setting data memory 107 and the command memory 108 may use an internal memory of the FPGA. The control signal circuit 109 sequentially reads the configuration information from the command memory 108. The control signal circuit 109 acquires one or more commands relating to the printing included in the configuration information from the command memory 108. When a print command is included in the configuration information, the control signal circuit 109 acquires the print data for one line related to the print command from the image memory 106. When a setting command is included in the configuration information, the control signal circuit 109 acquires the setting data related to the setting command from the setting data memory 107. The control signal circuit 109 generates a single-command control signal for storing one command relating to printing. The control signal circuit 109 generates a composite-command control signal for storing two or more commands related to the printing. An example of a configuration of the control signal circuit 109 will be described later.

The transmission circuit 110 is a circuit that transmits the control signal generated by the control signal circuit 109 to the inkjet head 20 via the signal line 40. Here, the term “transmit” includes any transfer method. For example, the transmission circuit 110 sequentially transmits the control signal(s) to the inkjet head 20 via the signal line 40 so that the transmission interval (cycle) of the start byte is a predetermined constant interval. The transmission circuit 110 transmits the control signals to the inkjet head 20 via the common signal line 40 regardless of the type of the command stored in the control signal. The transmission circuit 110 transmits a control signal to the inkjet head 20 via the common signal line 40 regardless of whether the signal is a single-command control signal or a composite-command control signal. Therefore, the transmission circuit 110 transmits the composite-command control signal to the inkjet head 20 via the signal line 40 used to transmit the single-command control signal to the inkjet head 20.

The inkjet head 20 is a device that forms an image on a recording sheet on the basis of a control signal from the controller 10. The inkjet head 20 includes a head drive circuit 201 and an actuator unit 202.

The head drive circuit 201 is a circuit that controls the actuator unit 202 based on the control signal. The head drive circuit 201 includes a receiving circuit 2011, an analysis circuit 2012, a print data buffer 2013, a setting data buffer 2014, and a drive signal circuit 2015.

The receiving circuit 2011 is a circuit that receives a control signal via the signal line 40. For example, the receiving circuit 2011 receives a single-command control signal via the signal line 40. For example, the receiving circuit 2011 receives the composite-command control signal via the same signal line 40 used for receiving the single-command control signal. Typically, the receiving circuit 2011 receives a composite-command control signal that stores at least two of a first setting, a second setting, and an execution command.

The analysis circuit 2012 is a circuit that analyzes a command stored in the control signal received by the receiving circuit 2011 and. For example, the analysis circuit 2012 is configured by an FPGA or the like. For example, the analysis circuit 2012 analyzes the one command stored in the single-command control signal. Based on detection of the print command stored in the print control signal, the analysis circuit 2012 stores the print data in the print data buffer 2013. The analysis circuit 2012 stores the setting data in the setting data buffer 2014 on the basis of detection of the setting command stored in the setting command packet. The analysis circuit 2012 can store the setting data in the setting data buffer 2014 with reference to designation of a buffer position and a size specified by the setting command. The analysis circuit 2012 may also store the setting data in a setting data temporary buffer (not illustrated) included in the head drive circuit 201. The analysis circuit 2012 can store the setting data in the setting data temporary buffer with reference to designation of a buffer position and a size specified by the setting command. The setting data temporary buffer is mainly a buffer used for temporary holding the setting data item to be changed, which will be described later, before saving in the setting data buffer 2014. The setting data temporary buffer has a configuration similar to that of the setting data buffer 2014. Based on the detection of the setting command stored in the execution setting control signal, the analysis circuit 2012 performs processing in accordance with the execution command.

The analysis circuit 2012 analyzes two or more different types of commands for printing stored in the composite-command control signal. The analysis circuit 2012 processes the print data on the basis of the detection of the print command stored in the composite-command control signal. For example, the analysis circuit 2012 stores the print data in the print data buffer 2013. The analysis circuit 2012 processes the setting data on the basis of the detection of the setting command stored in the composite-command control signal. For example, the analysis circuit 2012 stores the setting data in the setting data temporary buffer. The analysis circuit 2012 processes the execution command based on the detection of the execution command stored in the composite-command control signal. For example, the analysis circuit 2012 reflects the setting data held in the setting data temporary buffer to the setting data buffer 2014.

The print data buffer 2013 temporarily holds the print data. For example, the print data buffer 2013 holds the print data while changing the print data by storing the print data in the analysis circuit 2012 and extracting the print data by the drive signal circuit 2015. For example, the buffer size of the print data buffer 2013 corresponds to the data length of the print data for one line.

The setting data buffer 2014 temporarily holds the setting data. The setting data buffer 2014 includes storage areas corresponding to the respective gradations of 0 to 15. The setting data buffer 2014 holds setting data corresponding to the gradation levels of 0 to 15 in each storage area. All or a part of the setting data held in the setting data buffer 2014 may be changed. A configuration example of the setting data buffer 2014 will be described later.

The drive signal circuit 2015 generates drive signals for driving the actuator unit 202 based on the print data held in the print data buffer 2013 and the setting data held in the setting data buffer 2014. The drive signal circuit 2015 takes out the print data held in the print data buffer 2013. The drive signal circuit 2015 generates a drive waveform at each gradation of 0 to 15 based on the setting data corresponding to each of the gradations of 0 to 15 held in the setting data buffer 2014. The drive signal circuit 2015 generates drive signals for driving of a plurality of actuators #1 to #m included in the actuator unit 202 based on the drive waveform and the print data. The drive signal circuit 2015 supplies the drive signals to the actuator unit 202.

The actuator unit 202 includes a plurality of actuators #1 to #m. The actuators #1 to #m eject ink droplets from nozzles by changing a pressure in an ink chamber in accordance with the drive signals.

The conveyance unit 30 is a device that conveys a recording paper so that an image is formed by the ink jet head 20. For example, the conveyance unit 30 includes a plurality of guides and a plurality of conveyance rollers arranged along a path in which the recording paper is conveyed.

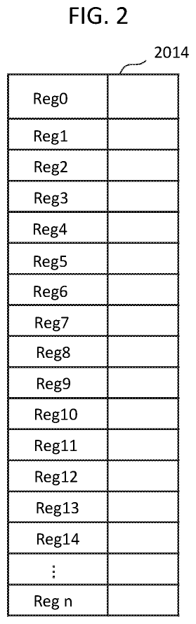

A configuration example of the setting data buffer 2014 will be described. FIG. 2 is a schematic diagram illustrating a configuration example of the setting data buffer 2014. The setting data buffer 2014 includes storage areas Reg (0) to Reg (n) that temporarily hold setting data corresponding to each of the gradations of 0 to 15. For example, the setting data buffer 2014 includes 212 or 1221 storage areas.

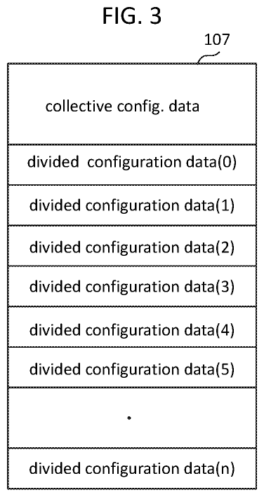

A configuration example of the setting data memory 107 will be described. FIG. 3 is a schematic diagram illustrating an example of the setting data memory 107. The setting data memory 107 includes a storage capacity for storing all the configuration data (referred to as the “collective configuration data” and also referred to as “config. data” in some contexts). The collective configuration data is data including setting data to be stored in each of the storage areas Reg (0) to Reg (n) of the setting data buffer 2014. For example, the collective configuration data is supplied by a setting control signal that is transmitted before the print processing is performed. The setting data memory 107 includes 212 or 1221 storage areas, for example.

The setting data memory 107 includes a storage area for individual print settings/parameters (configurations), which are referred to as divided configuration data (0) to divided configuration data (n). For example, the setting data memory 107 includes a storage area for 212 or 1221 pieces of configuration data. The configuration data (0) to the configuration data (n) are respectively associated with the storage areas Reg (0) to Reg (n) of the setting data buffer 2014. The divided configuration data (0) to (n) are each individual settings to be stored in the storage areas Reg (0) to Reg (n) of the setting data buffer 2014. That is, each of the divided configuration data (0) to the divided configuration data (n) is setting data to be stored in a different part or register of the setting data buffer 2014. The values for the divided configuration data (0) to (n) can be stored in a print and setting (PS) control signal or a print setting execution (PSE) control signal transmitted during the print processing.

The collective configuration data (that is, the group of each individual piece of configuration data (0) to configuration data (n)) is written to the setting data memory 107 by the processor 101, and can be updated as appropriate in response to control signals including a setting command or the like.

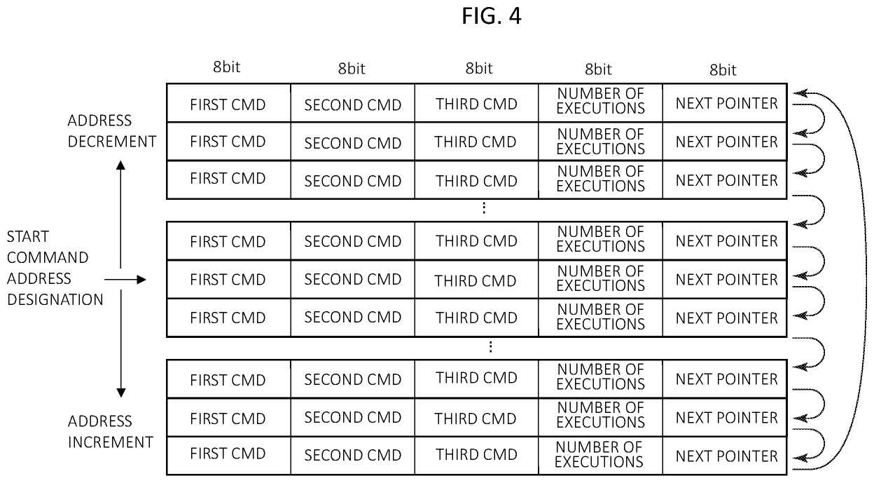

FIG. 4 is a schematic diagram illustrating a configuration example of the command memory 108.

The command memory 108 stores the configuration information for the control signal(s). The configuration information is used to generate a control signal for each line of printing. The configuration information includes information associated with one or more commands related to the printing. When the configuration information relates to a single command control signal, the configuration information includes just one command related to printing. When the configuration information relates to a composite-command control signal, the configuration information includes two or more commands related to printing. The configuration information in this example includes three commands related to printing at a maximum.

The configuration information includes a first CMD region, a second CMD region, and a third CMD region as areas for storing commands related to printing. (see FIG. 4) When the configuration information relates to a single-command control signal, the configuration information stores a command in the first CMD region. The configuration information may store a NOP in the second CMD region and/or the third CMD region.

When the configuration information relates to a composite-command control signal including two commands, the configuration information stores commands in the first CMD region and the second CMD region and a NOP in the third CMD region. When the configuration information relates to a composite-command control signal including three commands, the configuration information stores a command in the first to the third CMD regions. A command related to the printing stored in the first CMD region can also be referred to as a first command. A command related to the printing stored in the second CMD region can also be referred to as a second command. A command related to the printing stored in the third CMD region can also be referred to as a third command. In general, the first command, the second command, and the third command can be any commands from among print commands, setting commands, and execution commands, so long as the command types are not repeated (e.g., the first and second command are not both a print command).

The configuration information also includes the number of executions to be performed. When the configuration information relates to the single-command control signal, the number of executions is the number of repetitions for the transmission of the control signal (storing one command) related to the printing included in the configuration information. For example, in a case where the controller 10 transmits a print control signal repeatedly (multiple times), the number of executions indicates the number of times the print control signal is consecutively transmitted repeatedly. When the configuration information relates to the composite-command control signal, the number of executions is the number of repetitions of the transmission of the control signal (storing the two or more commands) related to the printing included in the configuration information. For example, in a case where the controller 10 transmits a PS control signal repeatedly, the number of executions indicates the number of times the PS control signal is to be repeated before moving on to a different control signal.

The configuration information also includes a next pointer. The next pointer is designation information for designating the next configuration information for generating control signals to be used after completion of the present configuration information.

In the command memory 108, the first bit of the pointer is configured with a code bit. Therefore, the command memory 108 is configured so as to be able to specify both upward and downward position addresses from the current pointer.

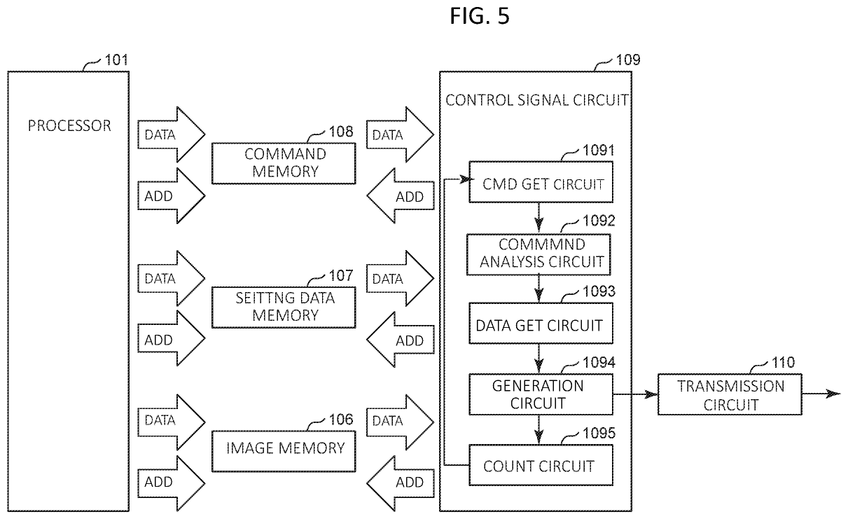

FIG. 5 is a block diagram illustrating a configuration example of the control signal circuit 109. The control signal circuit 109 includes a command get circuit 1091, a command analysis circuit 1092, a data get circuit 1093, a generation circuit 1094, and a count circuit 1095.

The command get circuit 1091 refers to the configuration information in the command memory 108 and acquires the one or more commands included in the configuration information from the command memory 108. The command get circuit 1091 acquires the first command, the second command, and the third command, in this order, from the configuration information.

For example, in response to reception of a print READY signal, the command get circuit 1091 refers to the configuration information at the start command address stored in the command memory 108. The start command address specifies the configuration information corresponding to the first line of the printing in the print processing. The start command address is specified by the processor 101. For example, in response to reception of a synchronization signal, the command get circuit 1091 acquires one or more commands included in the currently referred to (addressed) configuration information from the command memory 108.

The command get circuit 1091 can also change the configuration information to be referred to subsequently, as will be explained further below. After generating a control signal based on the current configuration information, the command get circuit 1091 refers to the next pointer in the configuration information. The command get circuit 1091 refers to the next configuration information on the basis of the pointer included in the current configuration information. The command get circuit 1091 thus acquires a command included in the next configuration information from the command memory 108.

When the configuration information relates to a single-command control signal, the command get circuit 1091 acquires just one command from the command memory 108. When the configuration information relates to a composite-command control signal, the command get circuit 1091 acquires two or more commands related to the printing from the command memory 108.

The command analysis circuit 1092 analyzes the command acquired by the command get circuit 1091. The command analysis circuit 1092 analyzes the first command, the second command, and the third command, which are acquired by the command get circuit 1091, in the order of the first command, the second command, and the third command. The command analysis circuit 1092 identifies presence or absence of data associated with the first command, based on the first command. When the data associated with the first command is present, the command analysis circuit 1092 analyzes the memory and the address in the memory stored in the memory based on the first command. The analysis result includes the presence or absence of data accompanying the first command and the memory address at which the data is stored. Similarly to the first command, the command analysis circuit 1092 also analyzes the second command and the third command.

The data get circuit 1093 acquires the data associated with the command relating to printing in accordance with the analysis result in the command analysis circuit 1092. When the configuration information contains a print command, the data get circuit 1093 acquires the print data associated with the print command from the image memory 106. When the configuration information is included in the configuration information, the data get circuit 1093 acquires the setting data associated with the setting command from the setting data memory 107. Note that, even if the configuration information includes an execution command, the data get circuit 1093 does not acquire the data associated with the execution command.

The generation circuit 1094 generates a control signal for storing the one or more commands related to the printing from the configuration information and the data acquired by the data get circuit 1093 as necessary. A description will be given of a case in which the configuration information relates to a single-command control signal. In this case, the generation circuit 1094 generates a single-command control signal for storing one command related to the printing included in the configuration information and the data acquired by the data get circuit 1093 as necessary.

The case where the configuration information is related to a composite-command control signal will be described. In this case, the generation circuit 1094 generates a composite-command control signal for storing two or more commands related to the printing from the configuration information and the data acquired by the data get circuit 1093 as necessary.

The count circuit 1095 counts the number of executions included in the configuration information. In response to the generation of the control signal based on the configuration information by the generation circuit 1094, the count circuit 1095 reduces the number of executions by 1.

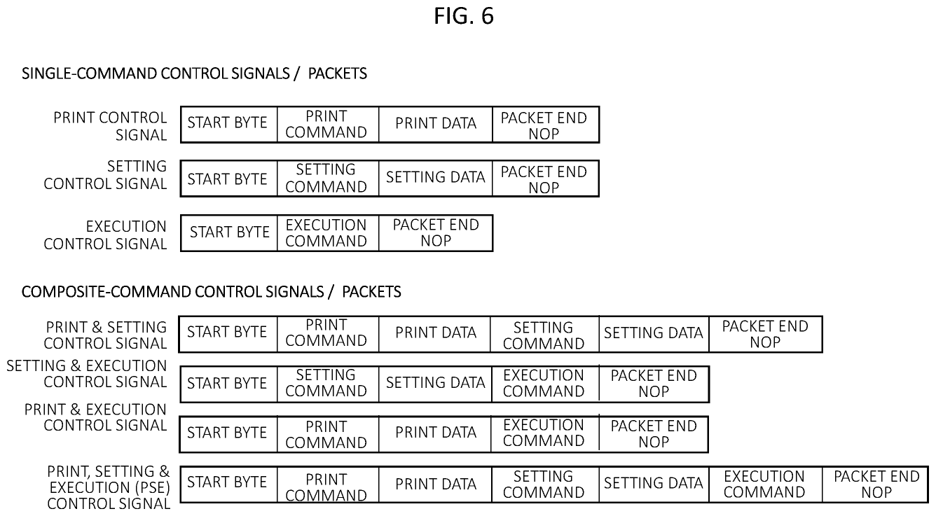

FIG. 6 is a diagram illustrating an example of the configuration of a control signal.

The print control signal is a single-command control signal for storing the first setting based on the print command and the print data between the start byte and the NOP.

The setting control signal is a single-command control signal for storing the second setting based on the setting command and the setting data between the start byte and the NOP.

The execution control signal is a single-command control signal for storing an execution command between the start byte and the NOP.

The print and setting (PS) control signal is a composite-command control signal that stores the first setting and the second setting between the start byte and the NOP. In FIG. 6, the depicted order of the arrangement of commands within a PS control signal may be changed as appropriate.

The setting and execution (SE) control signal is a composite-command control signal storing a second setting and an execution command between the start byte and the NOP. In FIG. 6, the depicted order of the arrangement of commands within a SE control signal may be changed as appropriate.

The print and execution (PE) control signal is a composite-command control signal storing a first setting and an execution command between the start byte and the NOP. In FIG. 6, the depicted order of the arrangement of commands within a PE control signal may be changed as appropriate.

The print, setting, and execution (PSE) control signal is a composite-command control signal storing a first setting, a second setting, and an execution command between the start byte and the NOP. In FIG. 6, the depicted order of the arrangement of commands within a PSE control command may be changed as appropriate.

In some example, a composite-command control signal may combine two or more of a first setting, a second setting, and an execution command by time division transmission process or the like.

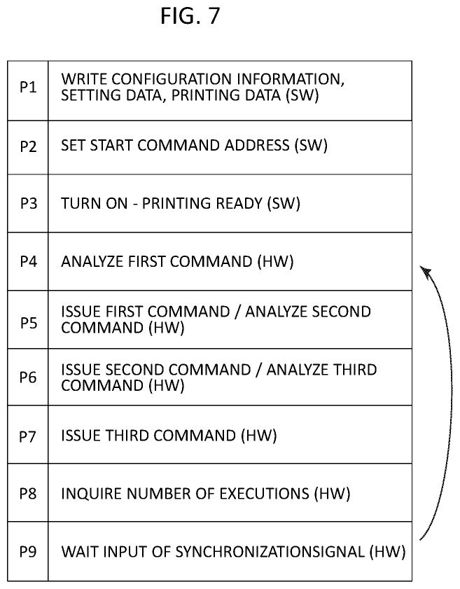

An operation of generating a control signal by the controller 10 will be described. FIG. 7 is a diagram illustrating an example of an operation of generating a control signal by the controller 10. The controller 10 generates a control signal by performance of process P1 to process P7 illustrated in FIG. 7. The text “SW” used in FIG. 7 indicates processing is performed via software and the processor 101. The text “HW” used in FIG. 7 indicates that processing associated with a step is performed via hardware, more particularly by the control signal circuit 109 in this example.

The process P1 will be described. Before the start of the printing process, the processor 101 writes the print data in the image memory 106. Before the start of the print processing, the processor 101 writes the setting data to the setting data memory 107. For example, the processor 101 writes the setting data to some or all of the storage areas of the configuration data (0) (config. data (0)) to configuration data (n) (config. data (n)). The processor 101 may write or rewrite the setting data in some or all of the individual storage areas for the configuration data (0) to the configuration data (n) during the print processing.

Before the start of the print processing, the processor 101 writes the configuration information into the command memory 108. The processor 101 writes the configuration information in consideration of the matters such as a transmission timing of a composite-command control signal for storing the setting data to be changed, number of composite-command control signals that store the setting data to be changed, a transmission timing of a composite-command control signal for storing an execution command. Note that the processor 101 may also change the configuration information stored in the command memory 108 during the print processing.

The process P2 will be described. The processor 101 specifies a start command address in the command memory 108.

The process P3 will be described. Upon starting the printing process, the processor 101 turns on the print READY signal.

The process P4 will be described. In response to the reception of the print READY signal, the command get circuit 1091 refers to the configuration information corresponding to the start command address stored in the command memory 108. The configuration information corresponding to the start command address is configuration information for generating a control signal corresponding to the first line of the printing. The command get circuit 1091 refers to the configuration information, and acquires the first command stored in the first CMD region of the configuration information from the command memory 108.

The command analysis circuit 1092 analyzes the first command acquired by the command get circuit 1091. The data get circuit 1093 acquires the data associated with the first command in accordance with the analysis result in the command analysis circuit 1092. For example, when the first command is a print command, the data get circuit 1093 acquires the print data associated with the print command from the image memory 106. Note that, for the first line, the command get circuit 1091 starts the processing in response to the reception of the print READY signal before the synchronization signal is received. This is because the first line data is set by the inkjet head 20 in the first line when the command get circuit 1091 receives the synchronization signal.

The process P5 will be described. The generation circuit 1094 outputs (or otherwise issues) the first command in response to the analysis of the first command by the command analysis circuit 1092. The generation circuit 1094 stores the first command so as to be contiguous with the start byte in the control signal. The generation circuit 1094 outputs the first command to the transmission circuit 110. Accordingly, the transmission circuit 110 can transmit the first command to the inkjet head 20 subsequent to the start byte. The generation circuit 1094 stores, in the control signal, data associated with the first command to continue the first command. The generation circuit 1094 outputs the data associated with the first command to the transmission circuit 110. As a result, the transmission circuit 110 can transmit the data associated with the first command to the inkjet head 20 subsequent to the first command.

The command analysis circuit 1092 analyzes the second command acquired by the command get circuit 1091. The command analysis circuit 1092 analyzes the presence or absence of data associated with the second command, based on the second command. The data get circuit 1093 acquires the data associated with the second command in accordance with the analysis result in the command analysis circuit 1092. For example, when the second command is a setting command, the data get circuit 1093 acquires, from the setting data memory 107, the setting data to be changed associated with the setting command. Note that, when the NOP is stored in the second CMD region, the command get circuit 1091 cannot acquire the second command. In this case, the data get circuit 1093 omits acquisition of the data associated with the second command.

The process P6 will be described. The generation circuit 1094 outputs (or otherwise issues) the second command in response to the analysis of the second command by the command analysis circuit 1092. The generation circuit 1094 stores the first command in the control signal so as to be contiguous with the data associated with the second command. The generation circuit 1094 outputs the second command to the transmission circuit 110. Accordingly, the transmission circuit 110 can transmit the first command to the inkjet head 20 subsequent to the data associated with the second command. Note that, when there is no data associated with the first command, the generation circuit 1094 stores the first command so as to be contiguous with the second command in the control signal. The generation circuit 1094 stores, in the control signal, data associated with the second command to continue the second command. The generation circuit 1094 outputs the data associated with the second command to the transmission circuit 110. As a result, the transmission circuit 110 can transmit the data associated with the second command to the inkjet head 20 subsequent to the second command.

The command analysis circuit 1092 analyzes the third command acquired by the command get circuit 1091. The command analysis circuit 1092 analyzes the presence or absence of data associated with the third command, based on the third command. The data get circuit 1093 acquires the data associated with the third command in accordance with the analysis result in the command analysis circuit 1092. For example, when the third command is an execution command, the data get circuit 1093 omits acquisition of data associated with the execution command. Note that, when the NOP is stored in the third CMD region, the command get circuit 1091 cannot acquire the third command. In this case, the data get circuit 1093 omits acquisition of the data associated with the third command.

The process P7 will be described. The generation circuit 1094 outputs (or otherwise issues) the third command in response to the analysis of the third command by the command analysis circuit 1092. The generation circuit 1094 stores the second command in the control signal so as to be contiguous with the data associated with the third command. The generation circuit 1094 outputs the third command to the transmission circuit 110. Accordingly, the transmission circuit 110 can transmit the second command to the inkjet head 20 subsequent to the data associated with the third command. Note that, when there is no data associated with the second command, the generation circuit 1094 stores the second command so as to be contiguous with the third command in the control signal. The generation circuit 1094 stores, in the control signal, data associated with the third command to continue the third command. The generation circuit 1094 outputs the data associated with the third command to the transmission circuit 110. As a result, the transmission circuit 110 can transmit the data associated with the third command to the inkjet head 20 subsequent to the third command.

The process P8 will be described. The command get circuit 1091 inquires of the count value of the number of executions counted by the count circuit 1095. The command get circuit 1091 determines whether or not to move from the current configuration information to the next configuration information corresponding to the address of the next pointer in accordance with the inquiry result. The inquiry result includes a count value of the number of executions as counted by the count circuit 1095.

When the count value of the number of executions counted by the count circuit 1095 reaches 0, the command get circuit 1091 refers to the next pointer included in the current configuration information. That is, after generating the control signal based on the configuration information currently being referred to by the generation circuit 1094, the command get circuit 1091 refers to the next pointer included in this configuration information. The command get circuit 1091 thus determines from the current configuration information to move to the next configuration information, which corresponds to the address of the next pointer in the current configuration information. On the other hand, when the count value of the number of executions counted by the count circuit 1095 has not reached 0, the command get circuit 1091 determines from the count value to keep using the current configuration information (rather than move on to the next configuration information).

The process P9 will be described. The command get circuit 1091 waits for the input of the synchronization signal. The control signal circuit 109 repeats the processing from the process P4 to the process P9 in response to reception of the synchronization signal for the second and subsequent lines of the printing, and generates a control signal for each line.

A case will be described in which the command get circuit 1091 determines to move from the current configuration information to the next configuration information at the address of the next pointer. In this case, in response to reception of the synchronization signal, the command get circuit 1091 acquires, from the command memory 108, a command included in the next configuration information.

A case where the command get circuit 1091 determines that the configuration information remains in the currently referred configuration information will be described. In this case, in response to reception of the synchronization signal, the command get circuit 1091 acquires, from the command memory 108, a command relating to printing included in the configuration information that is currently being referred to (current configuration information). The generation circuit 1094 generates a control signal storing one or more commands included in the configuration information currently being referred to (addressed) and the corresponding data acquired by the data get circuit 1093 for a number of times corresponding to the number of times of execution indicated in the configuration information.

As described above, when the configuration information indicates the number of executions is more than one, the control signal circuit 109 refers to the same configuration information a plurality of times, and generates a control signal accordingly. For each of these generated control signals, the combination of one or more commands included in the configuration information is the same, but the contents of the data accompanying the command(s) can be different from each other. For example, when the control signal circuit 109 generates a print control signal several times in repetition, the printing data stored in the print control signals can be different from each other. For example, when the control signal circuit 109 generates a print and setting (PS) control signal multiple times, the print data and the setting data stored in the PS control signals can be different from each other.

Some examples for changing at least part of the setting data held in the setting data buffer 2014 by using the composite-command control signal will be described. In the following, an example will be described in which the transmission circuit 110 transmits (to the inkjet head 20) a composite-command control signal for storing at least a first setting and a second setting by intermittent transmission to the inkjet head 20. Also, in the following, an example will be described in which the receiving circuit 2011 receives a composite-command control signal that includes at least the first setting and the second setting by intermittent reception of the control signal.

The first example is an example in which the PSE control signal is used. In this example, the transmission circuit 110 transmits, to the inkjet head 20, the PSE control signal to the inkjet head 20 for storing at least the first setting. The PSE control signal includes a part of the configuration data (0) to data (n) as the setting data to be changed. The setting data included in the PSE control signal is setting data to be stored in a corresponding part of the storage areas Reg (0) to Reg (n) of the setting data buffer 2014. The data length of the setting data in the PSE control signal in this example is shorter than the total data length of the setting data held in the setting data buffer 2014. The reason for this is because the transmission interval of the control signal for storing at least the first setting mainly depends on a printing frequency, a transfer rate, and the like, and is therefore extremely short. Therefore, the PSE control signal can also include the second setting and the execution command within a range that does not affect the transmission of an immediately subsequent print control signal.

In this example, the receiving circuit 2011 receives the PSE control signal.

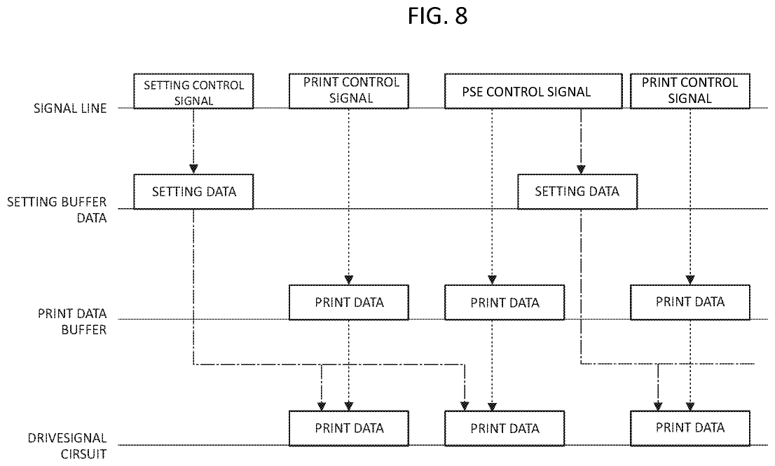

FIG. 8 is a diagram illustrating reception of the control signals according to the first example. The transmission circuit 110 first transmits the setting control signal to the inkjet head 20 via the signal line 40. It is assumed here that the setting control signal includes setting data to be stored in each of the storage areas Reg (0) to Reg (n) of the setting data buffer 2014. For example, the setting control signal may store the collective configuration data.

The receiving circuit 2011 receives the setting control signal via the signal line 40. Based on the detection of the setting command in the setting control signal, the analysis circuit 2012 stores the setting data of the setting control signal in the setting data buffer 2014. The analysis circuit 2012 also stores the setting data in the setting data temporary buffer.

In order to form an image on a recording paper or a sheet, the transmission circuit 110 transmits a control signal to the inkjet head 20 for storing at least the first setting as follows. The transmission circuit 110 transmits the control signals for storing at least the first setting to the inkjet head 20 such that the transmission intervals of the start bytes are at regular intervals.

The transmission circuit 110 next transmits a print control signal to the inkjet head 20 via the signal line 40. The receiving circuit 2011 receives the print control signal via the signal line 40. The analysis circuit 2012 stores the print data in the print data buffer 2013 on the basis of the detection of the print command in the print control signal. The drive signal circuit 2015 generates a drive signal based on the print data held in the print data buffer 2013 and the setting data held in the setting data buffer 2014.

Next, the transmission circuit 110 transmits the “print setting execution control signal” (PSE control signal) to the inkjet head 20 via the signal line 40. The PSE control signal includes the setting data to be changed.

The receiving circuit 2011 receives the PSE control signal via the signal line 40. The analysis circuit 2012 stores print data in the print data buffer 2013 based on the detection of the print command in the PSE control signal. The drive signal circuit 2015 generates a drive signal based on the print data held in the print data buffer 2013 and the setting data held in the setting data buffer 2014.

Based on the detection of the setting command in the PSE control signal, the analysis circuit 2012 stores the setting data to be changed in the setting data temporary buffer. Based on the detection of the execution command in the PSE control signal, the analysis circuit 2012 copies or transfers the setting data held in the setting data temporary buffer to the setting data buffer 2014. As a result, a part of the setting data held in the setting data buffer 2014 is changed to the updated setting data (provided in the PSE control signal).

Next, the transmission circuit 110 transmits another print control signal to the inkjet head 20 via the signal line 40. The receiving circuit 2011 receives the print control signal via the signal line 40. The analysis circuit 2012 stores the associated print data in the print data buffer 2013 on the basis of the detection of the print command in the print control signal. The drive signal circuit 2015 generates a drive signal based on the print data held in the print data buffer 2013 and the setting data held in the setting data buffer 2014. The setting data used at this stage by the drive signal circuit 2015 has a configuration in which a part of the setting data has been changed based on the PSE control signal command packet.

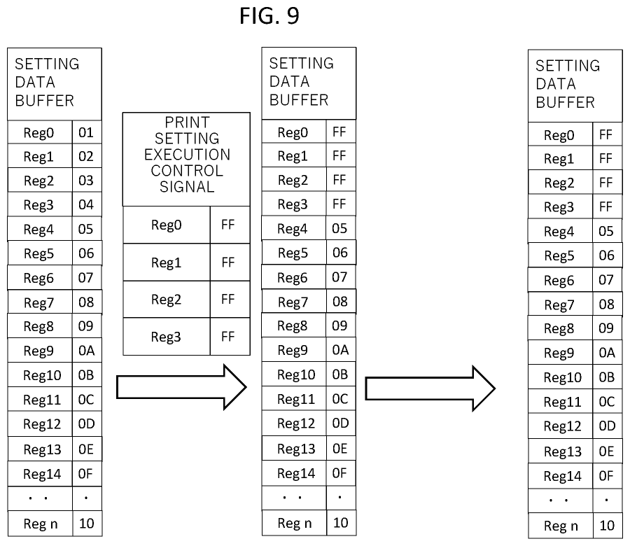

FIG. 9 is a diagram illustrating an example of changing of setting data in the setting data buffer 2014 in the example illustrated in FIG. 8.

The storage areas Reg (0) to Reg (n) of the setting data buffer 2014 initially store setting data included in the setting control signal. Similarly, the storage areas Reg (0) to Reg (n) of the setting data temporary buffer also store the setting data from the setting control signal. Based on the detection of a setting command, the analysis circuit 2012 stores the setting data to be changed in the setting data temporary buffer on the basis of the PSE control signal. It is assumed that the setting data to be changed is setting data stored in the storage areas Reg (0) to Reg (3) of the setting data buffer 2014. The analysis circuit 2012 refers to designation of the buffer position and the size specified by the setting command. The analysis circuit 2012 stores the setting data to be changed in the storage areas Reg (0) to Reg (3) of the setting data temporary buffer. The analysis circuit 2012 changes just the setting data held in the storage areas Reg (0) to Reg (3) out of all the storage areas Reg (0) to Reg (n) in the setting data temporary buffer.

Based on the detection of the execution command in the PSE control signal, the analysis circuit 2012 copies the setting data held in the setting data temporary buffer to the setting data buffer 2014. For example, the analysis circuit 2012 overwrites the setting data held in the storage areas Reg (0) to Reg (3) of the setting data buffer 2014 with the setting data of storage areas Reg (0) to Reg (3) held in the setting data temporary buffer. As described above, the analysis circuit 2012 can change any part of the setting data held in the setting data buffer 2014.

According to the first example, the controller 10 can transmit, to the inkjet head 20 via the signal line 40, a control signal in a form in which the setting data to be changed is associated with print data. The inkjet head 20 can receive, from the controller 10 via the signal line 40, a control signal in a form in which the setting data to be changed accompanies print data. Accordingly, the controller 10 and the inkjet head 20 can change the various settings of the inkjet head 20, such as the drive waveform, during an on-going printing operation. Furthermore, the controller 10 can transmit, to the inkjet head via the signal line 40, a control signal in which the execution command is stored, in addition to the setting data to be changed. The inkjet head 20 can receive, via the signal line 40, a control signal that includes an execution command in addition to the setting data of the change target. Accordingly, the controller 10 and the inkjet head 20 can change the settings of the inkjet head 20 in real time during printing.

The second example is an example in which one or more composite control signals are used. In this second example, the transmitting circuit 110 transmits a print and setting (PS) control signal at least once to the inkjet head 20. The transmission circuit 110 then transmits another composite-command control signal (e.g., a print and execution (PE) control signal) to the inkjet head 20.

The PS control signal stores setting data to be changed. The setting data stored in the PS control signal is setting data stored in a part of the storage areas Reg (0) to Reg (n) of the setting data buffer 2014. When the controller 10 cannot store the setting data to be changed in a single control signal due to the transmission interval of the control signals, the controller 10 can divide the setting data to be changed in to multiple PS control signals or the like. This setting data to be changed can also be referred to as divided setting data. The divided setting data is a subset of all the configuration data (0) to the configuration data (n). In this second example, the controller 10 divides the setting data into two or more PS control signals and stores the divided data accordingly. The setting data obtained by combining the divided setting data stored in the multiple PS control signals can correspond to all or just a portion of the configuration data (0) to configuration data (n). That is, the setting data obtained by combining the divided setting data stored in the one or more print setting control signals can be setting data to be stored in some or all of the storage areas Reg (0) to Reg (n) of the setting data buffer 2014.

In this example, the receiving circuit 2011 receives the PS control signal at least once in the transmission of the control signal for storing at least the first set to the inkjet head 20. The receiving circuit 2011 then receives a composite-command control signal for storing at least the first set and the execution command after receiving the PS control signal(s) for storing at least the first setting to the inkjet head 20.

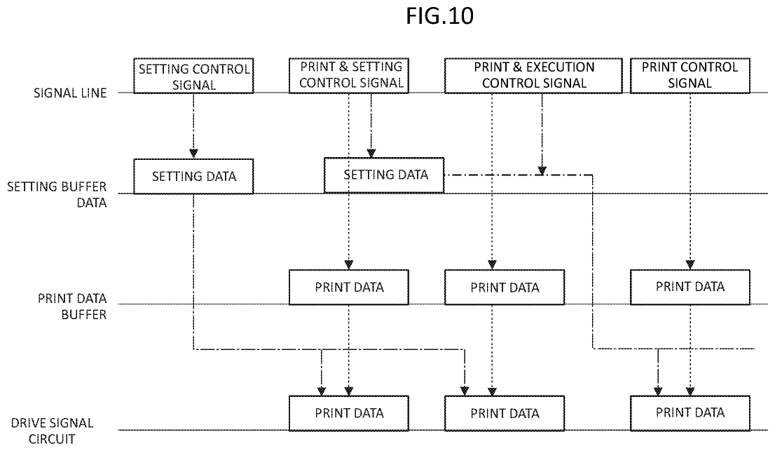

FIG. 10 is a diagram illustrating a second example in which one or more PS control signals and a PE control signal are received. FIG. 10 illustrates an example in which the transmission circuit 110 transmits one PS control signal, but the present disclosure is not limited thereto. The transmission circuit 110 may transmit two or more PS control signals in accordance with the amount of the setting data to be changed.

The transmission circuit 110 transmits the setting control signal to the inkjet head 20 via the signal line 40. It is assumed that the setting control signal includes setting data for storing in each of the storage areas Reg (0) to Reg (n) of the setting data buffer 2014. For example, the setting control signal may store the collective configuration data. The receiving circuit 2011 receives the setting control signal via the signal line 40. Based on the detection of the setting command in the setting control signal, the analysis circuit 2012 stores the setting data stored in the setting control signal in the setting data buffer 2014. The analysis circuit 2012 also stores the setting data stored in the setting control signal in the setting data temporary buffer.

In order to form an image on the recording paper, the transmission circuit 110 transmits a control signal for storing at least the first settings to the inkjet head 20 as follows. The transmission circuit 110 transmits the control signal(s) to the inkjet head 20 for storing at least the first settings such that the transmission intervals of the start bytes are at regular intervals.

The transmission circuit 110 transmits the PS control signal to the inkjet head 20 via the signal line 40. The PS control signal includes setting data to be changed. The receiving circuit 2011 receives the PS control signal via the signal line 40. The analysis circuit 2012 stores the print data in the print data buffer 2013 based on the detection of the print command in the PS control signal. The drive signal circuit 2015 generates a drive signal based on the print data held in the print data buffer 2013 as well as the setting data held in the setting data buffer 2014.

With the PS control signal, the analysis circuit 2012 stores the setting data for the change target in the setting data temporary buffer on the basis of the detection of the setting command.

Next, in this example, the transmission circuit 110 transmits the PE control signal to the inkjet head 20 via the signal line 40. The receiving circuit 2011 receives the PSE control signal via the signal line 40. The analysis circuit 2012 stores the print data in the print data buffer 2013 based on the detection of the print command in the PE control signal. The drive signal circuit 2015 generates a drive signal based on the print data held in the print data buffer 2013 as well as the setting data held in the setting data buffer 2014.

Based on the detection of the execution command in the PE control signal, the analysis circuit 2012 copies the setting data held in the setting data temporary buffer to the setting data buffer 2014. Accordingly, a part or all of the setting data held in the setting data buffer 2014 is changed.

Next, the transmission circuit 110 transmits the print control signal to the inkjet head 20 via the signal line 40. The receiving circuit 2011 receives the print control signal via the signal line 40. The analysis circuit 2012 stores the print data in the print data buffer 2013 on the basis of the detection of the print command in the print control signal. The drive signal circuit 2015 generates a drive signal based on the print data held in the print data buffer 2013 and the setting data held in the setting data buffer 2014. The setting data used at this stage by the drive signal circuit 2015 is the setting data as changed according to the previous PS control signal(s).

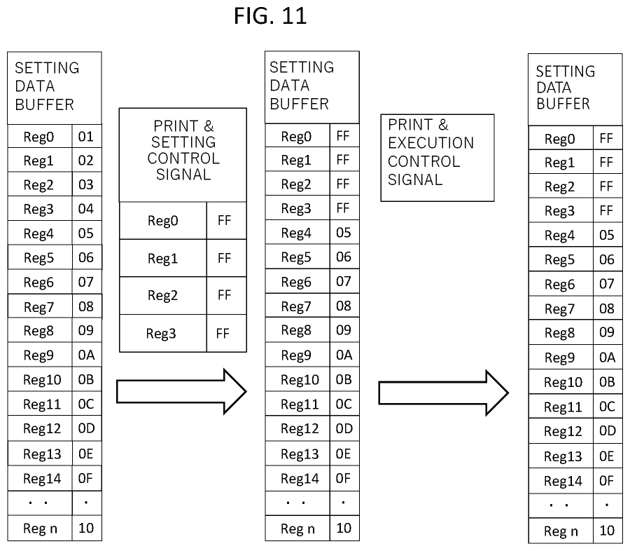

FIG. 11 is a diagram illustrating an example of changing of setting data in the setting data buffer 2014 in the example illustrated in FIG. 10.

The storage areas Reg (0) to Reg (n) of the setting data buffer 2014 initially store setting data set according to the setting control signal. Similarly, the storage areas Reg (0) to Reg (n) of the setting data temporary buffer store the setting data set according to the setting control signal. In the response to a received PS control signal, the analysis circuit 2012 stores the setting data to be changed in the setting data temporary buffer according to the detection of the setting command within the PS control signal. It is assumed in this example that the setting data to be changed is the setting data in the storage areas Reg (0) to Reg (3) of the setting data buffer 2014. The analysis circuit 2012 refers to designation of the buffer position and the size specified by the setting command. The analysis circuit 2012 stores the setting data to be changed in the storage areas Reg (0) to Reg (3) of the setting data temporary buffer. The analysis circuit 2012 changes only the setting data held in the storage areas Reg (0) to Reg (3) out of the storage areas Reg (0) to Reg (n) in the setting data temporary buffer.

Based on the detection of the execution command in a PE control signal, the analysis circuit 2012 copies/transfers the setting data held in the setting data temporary buffer to the setting data buffer 2014. For example, the analysis circuit 2012 overwrites the setting data held in the storage areas Reg (0) to Reg (3) of the setting data buffer 2014 with the setting data held in storage areas Reg (0) to Reg (3) of the setting data temporary buffer. As described above, the analysis circuit 2012 can change any part of the setting data being held in the setting data buffer 2014.

Note that, as described above, the transmission circuit 110 may transmit two or more PS control signals that store divided setting data. In such a case, the analysis circuit 2012 can change not only a part of the setting data held in the setting data buffer 2014 but also all of the setting data in the setting data buffer.

According to the second example, the controller 10 can transmit the control signal in a form in which the divided setting data is assigned to the print data to the inkjet head 20 one or more times via the signal line 40. The inkjet head 20 can receive a control signal in a form in which the divided setting data is assigned to the print data from the controller 10 via the signal line 40. Accordingly, the controller 10 and the inkjet head 20 can update some or all of the setting data held by the inkjet head 20 during a printing operation. Furthermore, the controller 10 can transmit a control signal to the inkjet head 20 for storing an execution command via the signal line 40, separately from the control signal for storing the divided setting data. The inkjet head 20 can receive, via the signal line 40, a control signal storing an execution command, separately from the control signal storing the divided setting data. Accordingly, the controller 10 and the inkjet head 20 can adjust a timing at which the settings of the inkjet head 20 are changed to be any timing.

The third example utilizes more than one PS control signal (command packet) and PSE control signal (command packet). The third example is different from the second example in that a composite-command control signal for storing an execution command is a PSE control signal.

The PS control signals and the PSE control signals each store setting data to be changed. The setting data stored in one PS control signal is setting data to be changed in a part (less than all) of the storage areas Reg (0) to Reg (n) of the setting data buffer 2014. The setting data stored in the PSE control signal likewise stores setting data to be changed in a part (less than all) of the storage areas Reg (0) to Reg (n) of the setting data buffer 2014. When the controller 10 cannot store the setting data to be changed in one control signal due to the transmission interval of the control signal, the controller 10 divides the setting data to be changed for transmission in multiple control signals. The controller 10 divides the setting data into one or more PS control signals and/or a PSE setting control signal, and stores the divided setting data in these multiple control signals. The setting data in the PS control signal(s) and the PSE control signal can collectively reflect a complete change in the stored configuration data (0) to the configuration data (n). That is, the setting data obtained by totaling the changes one or more PS control signals and the PSE control signal can be equal to all the setting data stored in the storage areas Reg (0) to Reg (n) of the setting data buffer 2014.

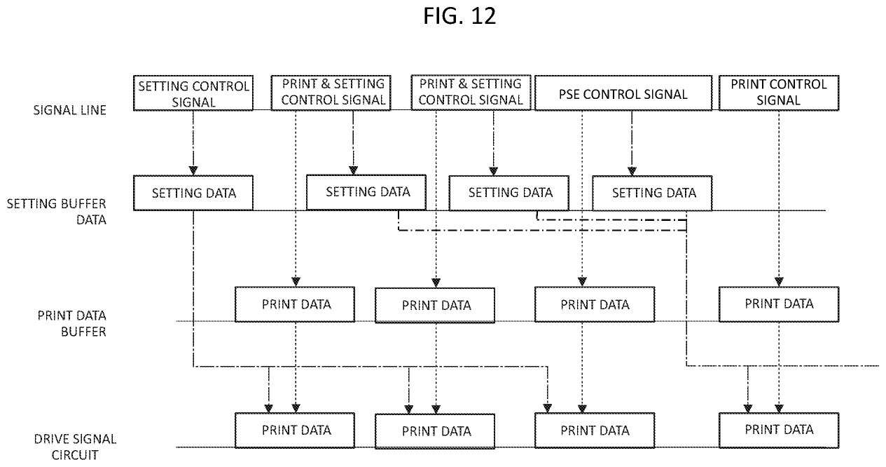

FIG. 12 is a diagram illustrating reception of one or more PS control signals and one or more PSE control signals as a third example. More particularly, FIG. 12 illustrates an example in which the transmission circuit 110 transmits two PS control signals, but the present disclosure is not limited thereto. The transmission circuit 110 may transmit just one PS control signal or may transmit three or more PS control signals according to the amount of the setting data to be changed.

The transmission circuit 110 initially transmits the setting control signal to the inkjet head 20 via the signal line 40. It is assumed that the setting control signal includes setting data for storing in each of the storage areas Reg (0) to Reg (n) of the setting data buffer 2014. For example, the setting control signal may store all the configuration data. The receiving circuit 2011 receives the setting control signal via the signal line 40. Based on the detection of the setting command in the setting control signal, the analysis circuit 2012 stores the setting data stored in the setting control signal in the setting data buffer 2014. The analysis circuit 2012 also stores the setting data stored in the setting control signal in the setting data temporary buffer.

In order to form an image on a recording paper, the transmission circuit 110 transmits a control signal for storing at least the first setting to the inkjet head 20 as follows. The transmission circuit 110 transmits the control signals to the inkjet head 20 for storing at least the first setting such that the transmission intervals of the start bytes are at regular intervals.

The transmission circuit 110 transmits the PS control signal to the inkjet head 20 via the signal line 40. The receiving circuit 2011 receives the PS control signal via the signal line 40. The analysis circuit 2012 stores the print data in the print data buffer 2013 based on the detection of the print command in the PS control signal. The drive signal circuit 2015 generates a drive signal based on the print data held in the print data buffer 2013 and the setting data held in the setting data buffer 2014.

In response to the PS control signal, the analysis circuit 2012 stores the changed setting data in the setting data temporary buffer on the basis of the detection of the setting command.

Next, the transmission circuit 110 transmits another PS control signal to the inkjet head 20 via the signal line 40. The receiving circuit 2011 receives the (second) PS control signal via the signal line 40. The analysis circuit 2012 stores the print data in the print data buffer 2013 based on the detection of the print command in this PS control signal. The drive signal circuit 2015 generates a drive signal based on the print data now held in the print data buffer 2013 and the setting data held in the setting data buffer 2014.

In response to the PS control signal, the analysis circuit 2012 stores the changed setting data in the setting data temporary buffer on the basis of the detection of the setting command.

Next, the transmission circuit 110 transmits a PSE control signal to the inkjet head 20 via the signal line 40. The receiving circuit 2011 receives the PSE control signal via the signal line 40. The analysis circuit 2012 stores the print data in the print data buffer 2013 based on the detection of the print command in the PSE control signal. The drive signal circuit 2015 generates a drive signal based on the print data now held in the print data buffer 2013 and the setting data held in the setting data buffer 2014.

Based on the detection of the setting command in the PSE command, the analysis circuit 2012 stores the changed setting data in the setting data temporary buffer.

Based on the detection of the execution command in the PSE control signal, the analysis circuit 2012 transfer the setting data held in the setting data temporary buffer to the setting data buffer 2014. Accordingly, a part or all of the setting data held in the setting data buffer 2014 is changed.

Next, in this third example, the transmission circuit 110 transmits a print control signal to the inkjet head 20 via the signal line 40. The receiving circuit 2011 receives the print control signal via the signal line 40. The analysis circuit 2012 stores the print data in the print data buffer 2013 on the basis of the detection of the print command in the print control signal. The drive signal circuit 2015 generates a drive signal based on the print data held in the print data buffer 2013 and the setting data held in the setting data buffer 2014. The setting data used at this stage by the drive signal circuit 2015 is setting data for which a part or all has been changed according to the previously received PS control signal(s) and the PSE control signal(s).

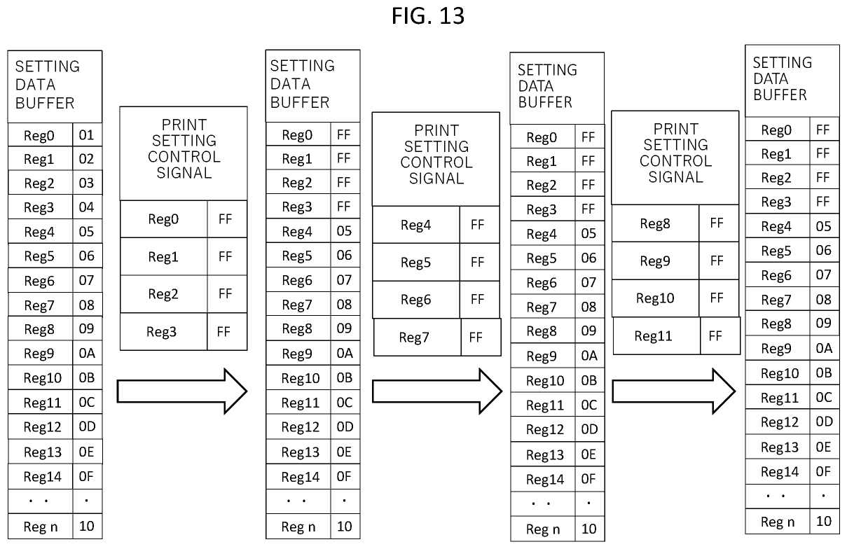

FIG. 13 is a diagram illustrating an example of changing (e.g., copying/transfer) of setting data to the setting data buffer 2014 in the example illustrated in FIG. 12.

The storage areas Reg (0) to Reg (n) of the setting data buffer 2014 initially store the setting data according to the setting control signal. Similarly, the storage areas Reg (0) to Reg (n) of the setting data temporary buffer store the setting data of the setting control signal. In response to the first PS control signal, the analysis circuit 2012 stores the setting data to be changed in the setting data temporary buffer based on the detection of the setting command in the PS control signal. It is assumed in this example that the setting data to be changed is setting data in the storage areas Reg (0) to Reg (3) of the setting data buffer 2014. The analysis circuit 2012 stores the setting data to be changed in the storage areas Reg (0) to Reg (3) of the setting data temporary buffer. The analysis circuit 2012 changes the just setting data held in the storage areas Reg (0) to Reg (3) rather than all of the storage areas Reg (0) to Reg (n) in the setting data temporary buffer. Based on the second PS control signal, the analysis circuit 2012 changes the setting data held in the storage areas Reg (4) to Reg (7) of the setting data temporary buffer. The analysis circuit 2012 next changes the setting data held in the storage areas Reg (8) to Reg (11) of the setting data temporary buffer, on the basis of the PSE control signal.

Based on the detection of the execution command in the PSE control signal, the analysis circuit 2012 copies/transfers the setting data held in the setting data temporary buffer to the setting data buffer 2014. For example, the analysis circuit 2012 overwrites the setting data held in storage areas Reg (0) to Reg (11) of the setting data buffer 2014 with the setting data held in the storage areas Reg (0) to Reg (11) of the setting data temporary buffer. As described above, the analysis circuit 2012 can change any part or all of the setting data held in the setting data buffer 2014.

Note that, as described above, the transmission circuit 110 may also transmit three or more PS control signals and more than one PSE control signals. In this case, the analysis circuit 2012 can also change any part or all of the setting data held in the setting data buffer 2014.

According to the third example, the controller 10 can transmit the control signal in a form in which the divided setting data is assigned to the print data to the inkjet head 20 one or more times via the signal line 40. The inkjet head 20 can receive the control signal in a form in which the divided setting data is assigned to the print data from the controller 10 via the signal line 40 one or more times. Accordingly, the controller 10 and the inkjet head 20 can transmit and receive some or all of the setting data held by the inkjet head 20 during the printing. Further, the controller 10 can transmit, to the inkjet head 20 via the signal line 40, a control signal in which an execution command is stored along with the setting data. The inkjet head 20 can receive, via the signal line 40, a control signal that includes an execution command in addition to setting data. Accordingly, the controller 10 and the inkjet head 20 can change the various settings of the inkjet head 20 in real time during a printing operation.

According to an embodiment, the controller 10 generates a control signal using the image memory 106, the setting data memory 107, the command memory 108, and the control signal circuit 109. The controller 10 generates a control signal by a hardware configuration instead of software and thus generates a composite-command control signal in a short time. Therefore, the controller 10 can also transmit the composite-command control signal at same the short transmission interval of the control signal during the printing.

According to an embodiment, the controller 10 writes the configuration information to the command memory 108 by means of the processor 101. When it is desired to change the setting of the inkjet head 20 such as a driving waveform in response to a temperature change occurring during printing, the controller 10 can appropriately rewrite the configuration information by software. Accordingly, the controller 10 can realize high-quality printing by compensating for the temperature change.

According to the embodiment, the controller 10 writes the setting data in the setting data memory 107 using the processor 101. When it is desired to change a setting of the inkjet head 20 such as a driving waveform in accordance with a temperature change during the printing, the controller 10 can appropriately rewrite the individual configuration settings (data) by software. The control apparatus 10 can realize high-quality printing corresponding to the temperature change.

According to an embodiment, the configuration information is configured to include the number of executions (repetitions). By referring to the number of executions included in the configuration information, the controller 10 can repeatedly generate, in a short time, a control signal for storing the same combination of commands. Further, since the command memory 108 can store the configuration information for generating the control signals for a plurality of lines together, it is possible to save memory capacity.

According to an embodiment, the configuration information is configured to include a next pointer. The controller 10 refers to the next pointer included in the configuration information, and can generate the control signal in a short time by referring to the configuration information in a short period of time.

Note that, in the present embodiment, the analysis circuit 2012 saves the setting data stored in the control signal in the setting data temporary buffer regardless of the type of the control signal, but the present disclosure is not limited to this configuration. For example, the setting command may include designation of a necessity to store the setting data in the setting data buffer 2014 or a designation of a necessity to store the setting data in the setting data temporary buffer. For example, in the setting control signal, the setting command may include a designation indicating a necessity of saving the changed setting data to the setting data buffer 2014 or designation indicating it is unnecessary to store the changed setting data in the setting data temporary buffer. For example, in the PSE control signal, as described above, the setting command may include the designation whether or not the changed setting data should be saved in the setting data temporary buffer. In these other examples, the analysis circuit 2012 saves the setting data in the setting data buffer 2014, but can omit saving in the setting data temporary buffer.

Note that the present disclosure has been described with the inkjet printer 1 as one example, but the present disclosure is not limited thereto. The present disclosure is also applicable to various other printer types, such as a thermal printer. In general, the present disclosure is applicable to any printer or other apparatus that transmits a plurality of types of commands relating to printing from a control unit to a printer head via a common signal line.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. A printer head control device, comprising:
a command memory for storing command configuration information indicating a configuration of a packet to be transmitted to a printer head, each packet including at least one command;
a print data memory for storing print data to be transmitted to the printer head;
a setting data memory for storing setting data related to printing parameters for the printer head;
a command get circuit configured to acquire commands included in the command configuration information stored in the command memory;
a data get circuit configured to acquire the print data from the print data memory when a print command is included in the command configuration information and to acquire the setting data from the setting data memory when a setting command is included in the command configuration information; and
a generation circuit configured to generate the packet including the at least one command and data associated with the at least one command as acquired by the data get circuit.

2. The printer head control device according to claim 1, further comprising:
a processor configured to write the command configuration information to the command memory.

3. The printer head control device according to claim 1, further comprising:
a processor configured to write the setting data to the setting data memory.

4. The printer head control device according to claim 1, wherein
the command configuration information includes a value indicating a number of times a packet corresponding to the command configuration information is to be transmitted to the printer head, and
the generation circuit is configured to repeatedly generate a packet corresponding to the command configuration information until the value is reached.

5. The printer head control device according to claim 4, wherein the data get circuit is configured to acquire data corresponding to the at least one command in the command configuration information for each generated packet corresponding to the command configuration, the acquired data being different for each generated packet.

6. The printer head control device according to claim 4, wherein, when the command configuration information includes at least two commands, the generated packets each include the at least two commands.

7. The printer head control device according to claim 1 wherein, when the command configuration information includes at least two commands, the packet generated by the generation circuit include the at least two commands and data associated with the at least two commands as acquired by the data get circuit.

8. The printer head control device according to claim 1, wherein the command configuration information includes designation information designating an address in the command memory of the next command configuration information to be used for a subsequent packet.

9. The printer head control device according to claim 8, wherein the command get circuit is configured to refer to the designation information and then acquire a command included in the next command configuration information.

10. The printer head control device according to claim 1, further comprising:
a transmission circuit configured to transmit the packet generated by the generation circuit to the printer head.

11. A print head controller, comprising:
a transmission circuit configured to transmit control signals to a print head for driving the print head in a printing operation;
a command memory for storing command configuration information indicating a configuration of a command packet to be transmitted to the print head as one control signal, each packet including at least one command related to the printing operation;
a print data memory for storing print data to be transmitted to the print head during the printing operation;
a setting data memory for storing setting data related to printing parameters for the print head during the printing operation;
a command get circuit configured to acquire commands included in the command configuration information stored in the command memory;
a data get circuit configured to acquire the print data from the print data memory when a print command is included in the command configuration information and to acquire the setting data from the setting data memory when a setting command is included in the command configuration information; and
a generation circuit configured to generate the packet including the at least one command and data associated with the at least one command as acquired by the data get circuit.

12. The print head controller according to claim 11, further comprising:
a processor configured to write command configuration information to the command memory during the printing operation.

13. The print head controller according to claim 12, wherein the processor is further configuration to write setting data to the setting data memory during the printing operation.

14. The print head controller according to claim 13, wherein
the processor is configured to write command configuration information indicating two different commands are to be included in a single packet.

15. The print head controller according to claim 14, wherein
one of the two different commands is a setting command,
the other of the two commands is a print command,
the data get circuit acquires setting data written to the setting data memory by the processor during the printing operation, and
the printing corresponding to the print command in the packet is performed in the printing operation according to updated printing parameters set according to the setting command in the packet.

16. The print head controller according to claim 11, wherein the transmission circuit is configured to transmit control signals to the print head at fixed intervals during the printing operation.

17. An image forming apparatus, comprising:
a print head configured to form an image on a sheet according to image data in a printing operation; and
a print head controller including:
a command memory for storing command configuration information indicating a configuration of a packet to be transmitted to the print head during the printing operation, each packet including at least one command;
a print data memory for storing print data to be transmitted to the print head in the printing operation;
a setting data memory for storing setting data related to printing parameters for the print head in the printing operation;
a command get circuit configured to acquire commands included in the command configuration information stored in the command memory;
a data get circuit configured to acquire the print data from the print data memory when a print command is included in the command configuration information and to acquire the setting data from the setting data memory when a setting command is included in the command configuration information; and
a generation circuit configured to generate the packet including the at least one command and data associated with the at least one command as acquired by the data get circuit.

18. The image forming apparatus according to claim 17, further comprising:
a processor configured to write the command configuration information to the command memory and setting data to the setting data memory.

19. The image forming apparatus according to claim 18, wherein, when the processor writes setting data to the setting data memory during the printing operation, a packet subsequently generated during the printing operation and including a setting command includes the setting data written to the setting data memory during the printing operation.

20. The image forming apparatus according to claim 17, wherein, when the command configuration information includes at least two commands, a generated packet includes the at least two commands.
